(19) United States
(12) Patent Application Publication
(10) Pub. No.: US 2017/0130066 A1
(43) Pub. Date: May 11, 2017

(54) Fire Protection Composition and Use Thereof

(71) Applicant: Hiliti Aktiengesellschaft, Schaan (LI)

(72) Inventors: Martin LANG, Planegg (DE); Sebastian SIMON, Buchloe Lindenberg (DE); Juliane MARAUSKA, Augsburg (DE)

(21) Appl. No.: 15/318,757

(22) PCT Filed: Jun. 17, 2015
(86) PCT No.: PCT/EP2015/063540

§ 371 Date: Dec. 14, 2016

(30) Foreign Application Priority Data
Jun. 18, 2014 (EP) 14172913.7

(51) Int. Cl. C09D 5/18; C09D 135/02; H02G 3/04; C09D 4/00

(52) U.S. Cl. CPC C09D 5/18; C09D 5/185; C09D 4/00; C09D 135/02; H02G 3/0412

(57) ABSTRACT

Described is a fireprotection composition comprising a constituent A which contains a multifunctional Michael acceptor having at least two electron-deficient multiple carbon bonds per molecule as a functional Michael acceptor group, further comprising a constituent B which contains a multifunctional Michael donor having at least two thiol groups per molecule as a functional Michael donor group, and comprising a constituent C which contains at least one ablative fire-retardant additive. The claimed composition makes it possible to apply, in a simple and rapid manner, coatings that have the layer thickness required for the particular fire resistance rating, the layer thickness being reduced to a minimum but nevertheless achieving a great fire protection effect. The claimed composition is particularly suitable for fire protection, especially as a coating for cables and cable routes, in order to increase the fire resistance rating.

The present invention relates to a composition, in particular an ablative composition which contains a binder based on thiol-ene as well as the use thereof for fire protection, in particular for the coating of components such as supports, beams, frame members, insulation systems, e.g. soft fittings, cables, cable bundles or cable routes for increasing the fire resistance grading.

In the case of fires, cable routes constitute particular points of danger for a number of reasons. On the one hand, in the case of fires of cables insulated with plastic, intensive smoke development occurs with the emission of harmful, in part toxic materials. On the other hand, a fire can quickly spread along cable routes and under certain circumstances the fire can be guided to a point that is far away from the original source of the fire. In the case of cable systems, there is also the problem that in the case of these cables the effect of the insulation decreases due to thermal impact or combustion and an interruption of the current flow can occur due to short-circuiting and thus the cables are destroyed or are not functional.

Electrical cables or lines are often laid in hallways and subdivided from there into the adjoining rooms. These hallways serve as escape and rescue routes in event of fire, which become unusable in the case of fires of cable installations due to smoke development and toxic fire gases, and e.g. burning PVC releases highly-corrosive gases. Large groups of cables thus constitute a significant risk potential, in particular in industrial construction, in power stations, in hospitals, large and administrative buildings and generally in buildings with high installation density. The cable insulations are often the relevant fire load in these buildings and cause fires lasting a long time with fire room temperatures in worst case scenarios up to over 1000° C. For the mentioned reasons, particular attention must be paid to cable routes with regard to fire protection measures.

In order to prevent, at least for a period of time, the dangers of the lack of functionality of the cables and the strong fire load increase by the cables, it is known to spatially separate the cables by non-flammable construction materials of the building material class A1 or A2 by laying the cables e.g. in installation and/or functional maintenance channels. However, this requires significant labor input. In addition, there is a high space requirement due to complex constructions which, in addition to the weight of the cable routes, must take into consideration the weight of the installation and/or maintenance channels. To this end, cables and cable routes are often wrapped with insulating materials such as aluminum oxide silica mats or mineral wool mats. In order to achieve sufficient fire protection, the material must be very thick. However, this leads to problems with respect to the distances between the protected object and adjacent or overlaid objects. Furthermore, these materials cause problems during normal operation due to their thermal insulating properties. One of these problems is termed “reduction of the current carrying capacity”. This means that the heat generated by electrical cables in the cable pipe or the cable route can no longer be dissipated in the region of the insulation, which leads to the secure current operating level permitted in these cables being reduced or overheating of the cables taking place. These disadvantages make this type of fireproofing very inflexible with respect to the usage area thereof.

In order to avoid these disadvantages, it is also known to apply coatings for the protection of electrical cables which becomes intumescent with thermal impact in the event of fire, i.e. they foam and thus form an insulation layer or they receive heat due to physical and chemical processes and thus act in a cooling manner.

With intumescent coatings it is possible to prevent the involvement of cables in the event of fire for 30 minutes or longer. Coated cables of this type are often laid on cable routes. However, in this regard it has been shown that in the case of a vertical or inclined arrangement of the cable routes, a completely foamed insulation layer cannot prevent the spread of fire without additional measures. During heating, the cables between the cable clamps deforms so much that the coating forming the insulation layer tears and partially spalls. The resulting foam also comes loose from the cables and falls off. In the case of coating applied after laying the cables, the cables in the region of the clamp constructions are not fully accessible. As a result, in the case of a vertical or inclined arrangement of cable routes only a foam of low thickness develops in the event of fire in the region of the clamp constructions, which is no longer sufficient as fire proofing for 30 minutes. In the case of laying PVC cables, the known problems in the event of fire thus occur again.

It is also known to use non-halogen cables provided in a flame-retardant or flame-resistant manner and which are flame-resistant and produce little smoke and have poor fire transfer properties. However, these cables are very expensive and are thus used only under extremely hazardous conditions.

In order to avoid the disadvantages of intumescent coatings, materials are applied to the cables and cable holders in cable routes, said materials exhibit an ablation effect, i.e. acting in a cooling manner under the influence of heat and becoming ceramic, as described for example in DE 196 49 749 A1. A method is described herein for designing fire protection for flammable components or components that are a heat risk, and the components are provided with a coating which contains, as the binder, an inorganic material made of finely-ground hydraulic binders such as calcium silicate, calcium aluminate or calcium ferrite, to which is added ablative materials such as aluminum or magnesium hydroxide. What is a disadvantage with this measure is that, on the one hand, the application of the material exhibiting the ablation effect is time-consuming and, on the other hand, the adherence of the material to the cables and to the cable holders poses a problem.

Other coating systems currently available on the market, which do not have some of the above-mentioned disadvantages, are single-component coating compositions on the basis of polymer dispersions which contain endothermically decomposing compounds. What is disadvantageous with these coatings is, on the one hand, the relatively long drying time of the coating and associated low dry layer thickness since these systems dry physically, i.e. through the evaporation of the solvent. A plurality of successive applications is thus required for thicker coatings, which also makes these systems time-consuming and labor intensive and thus uneconomical.

The object therefore underlying the invention is to provide an ablative coating system of the type mentioned at the outset which avoids the mentioned disadvantages which is in particular not solvent or water-based and has rapid hardening, is easy to apply owing to correspondingly adapted viscosity and requires only low layer thickness owing to the achievable high degree of filling.

This object is achieved by the composition according to claim 1. Preferred embodiments can be inferred from the dependent claims.

The subject matter of the invention is therefore a fire protection composition having a constituent A, which contains a multi-functional Michael acceptor, which has at least two electron-deficient multiple carbon bonds per molecule, having a constituent B, which contains a multi-functional Michael donor, which has at least two thiol groups per molecule (thiol-functionalized compound) and having a constituent C, which contains at least one ablative fire protection additive.

Coatings with the layer thickness required for the respective fire resistance grading can be more easily and quickly applied by means of the composition according to the invention. The advantages achieved by means of the invention are substantially to be seen by the fact that in comparison to the systems on a solvent or water basis with their inherent long hardening times, the working time can be significantly reduced.

A further advantage is that the composition according to the invention can have a high degree of filling with the fire protection additive such that even with thin layers a strong insulating effect is achieved. The possible high degree of filling of the composition can be achieved even without the use of slightly volatile solvents. Accordingly, the material input reduces, which has a favorable effect on the material costs in particular in the case of an extensive application. This is achieved in particular by the use of a reactive system which does not dry physically, but rather hardens chemically via an addition reaction. The compositions thus do not suffer from any volume loss through the drying of solvents or of water in the case of water-based systems. A solvent content of approximately 25% is thus typical in the case of a classic system. This means that from a 10 mm wet film layer, only 7.5 mm remains on the substrate to be protected as the actual protective layer. In the case of the composition according to the invention, more than 95% of the coating remains on the substrate to be protected.

In the event of fire, the binder softens and the fire protection additives contained therein decompose depending on the additives used in an endothermic physical or chemical reaction with the development of water and inert gases, which, on the one hand, leads to the cooling of the cables and, on the other hand, to the diluting of the flammable gases or through the formation of a protective layer which protects the substrate from heat and attack by oxygen and, on the other hand, prevents the spreading of the fire through the combustion of the coating.

The compositions according to the invention exhibit excellent adherence to different subgrades compared to solvent or water-based systems if these are applied without primer such that they can be used universally and adhere not only to lines to be protected, but also to other carrier materials.

In order to improve the understanding of the invention, the following explanations of the terminology used herein are considered useful. In the context of the invention:
a “Michael addition” is generally a reaction between a Michael donor and a Michael acceptor, often in the presence of a catalyst, such as for example a strong base, and a catalyst not being absolutely necessary; the Michael addition is known sufficiently in the literature and described often;
a “Michael acceptor” is a compound having at least one functional Michael acceptor group which contains a Michael-active carbon multiple bond such as a C═C double bond or C—C triple bond which is not aromatic and is electron-deficient; a compound having two or more Michael-active carbon multiple bonds is denoted as a multi-functional Michael acceptor; a Michael acceptor can have one, two, three or more separate functional Michael acceptor groups; each functional Michael acceptor group can have a Michael-active carbon multiple bond; the total number of Michael-active carbon multiple bonds to the molecule is the functionality of the Michael acceptor; as used herein, the “skeleton” of the Michael acceptor is the other part of the acceptor molecule to which the functional Michael acceptor group can be bonded;
“electron-deficient” means that the carbon multiple bond carries electron-withdrawing groups in direct proximity, i.e. generally at the carbon atom adjacent to the multiple bond, said electron-withdrawing groups remove electron density from the multiple bond, such as C═O and/or C≡N;
a “Michael donor” is a compound having at least one functional Michael donor group, which is a functional group, which contains at least one Michael-active hydrogen atom, which is a hydrogen atom that is attached to a hetero atom, such as thiols; a compound having two or more Michael-active hydrogen atoms is denoted as a multi-functional Michael donor; a Michael donor can have one, two, three or more separate functional Michael donor groups; each functional Michael donor group can have a Michael-active hydrogen atom; the total number of Michael-active hydrogen atoms of the molecule is the functionality of the Michael donor; as used herein, the “skeleton” of the Michael donor is the other part of the donor molecule to which the functional Michael donor group is bonded; anions of the Michael donors are also included by this definition;
“ablative” means that in the case of the impact of high temperatures, i.e. above 200° C., as can occur for example in the event of fire, a series of chemical and physical reactions takes place, which require energy in the form of heat, and this energy is removed from the environment; this term is used synonymously with the term “endothermically decomposing”;
“(Meth)acryl . . . / . . . (meth)acryl . . . ” means that both “Methacryl . . . / . . . methacryl . . . ” and “Acryl . . . / . . . acryl . . . ” compounds should be included.
“oligomer” is a molecule with 2 to 5 repeat units and a “polymer” is a molecule with 6 or more repeat units and can have structures which are linear, branched, star-shaped, looped, hyperbranched or crosslinked; polymers can have a single type of repeat unit (“homopolymers”) or they can have more than one type of repeat unit (“copolymers”). A “resin” is a synonym for polymer, as used herein.

It is generally accepted that the conversion of a Michael donor with a functionality of two with a Michael acceptor with a functionality of two will lead to linear molecular structures. Often, molecular structures have to be generated, which are branched and/or crosslinked, for which the use of at least one ingredient with a functionality greater than two is required. Thus the multi-functional Michael donor or the multi-functional Michael acceptor or both preferably have a functionality greater than two.

According to the invention, any compound which has at least two functional groups constituting Michael acceptors can be used as the multi-functional Michael acceptor. Each functional group (Michael acceptor) is in this regard bonded either directly or via a linker to a skeleton.

According to the invention, any compound which has at least two thiol groups as functional Michael donor groups can be used as the Michael donor, said functional Michael donor groups can add to electron-deficient double bonds in a Michael addition reaction (thiol-functionalized compound). Each thiol group is in this regard bonded either directly or via a linker to a skeleton.

The multi-functional Michael acceptor or the multi-functional Michael donor of the present invention can have any wide number of skeletons, and these can be identical or different.

According to the invention, the skeleton is a monomer, an oligomer or a polymer.

In some embodiments of the present invention, the skeletons have monomers, oligomers or polymers with a molecular weight (mw) of 50,000 g/mol or less, preferably 25,000 g/mol or less, more preferably 10,000 g/mol or less, even more preferably 5,000 g/mol or less, even more preferably 2,000 g/mol or less and most preferably 1,000 g/mol or less.

As monomers which are suitable as skeletons, alkanediols, alkylene glycols, sugars, polyvalent derivatives thereof or mixtures thereof and amines, such as ethylene diamines and hexamethylene diamines and thiols can be mentioned by way of example. As oligomers or polymers which are suitable as skeletons, the following can be mentioned by way of example: polyalkylene oxide, polyurethane, polyethylene vinyl acetate, polyvinyl alcohol, polydiene, hydrogenated polydiene, alkyd, alkyd polyester, (meth)acrylic polymer, polyolefin, polyester, halogenated polyolefin, halogenated polyester, polymercaptan, as well as copolymers or the mixtures thereof.

In preferred embodiments of the invention, the skeleton is a polyvalent alcohol or a polyvalent amine, and these can be monomer, oligomer or polymer in nature. More preferably, the skeleton is a polyvalent alcohol.

As polyvalent alcohols which are suitable as skeletons, the following can be mentioned by way of example: alkanediols, such as butanediol, pentanediol, hexanediol, alkylene glycol, such as ethylene glycol, propylene glycol and polypropylene glycol, glycerin, 2-(hydroxymethyl)propane-1,3-diol, 1,1,1-tris(hydroxymethyl)ethane, 1,1,1-trimethylolpropane, di(trimethylolpropane), tricyclodecane dimethylol, 2,2,4-trimethyl-1,3-pentanediol, bisphenol A, cyclohexane dimethanol, alkoxylated and/or ethoxylated and/or propoxylated derivatives of neopentyl glycol, tertraethylene glycol cyclohexane dimethanol, hexanediol, 2-(hydroxylmethy)propane-1,3-diol, 1,1,1-tris(hydroxymethyl)ethane, 1,1,1-trimethylolpropane and castor oil, pentaerythritol, sugars, polyvalent derivatives thereof or mixtures thereof.

As linkers, any units, which are suitable, can be used to connect skeleton and functional group. For thiol-functionalized compounds, the linker is preferably selected from the structures (I) to (XI). For Michael acceptors, the linker is preferably selected from the structures (XII) to (XIX).

1: Bond to functional group

2: Bond to skeleton

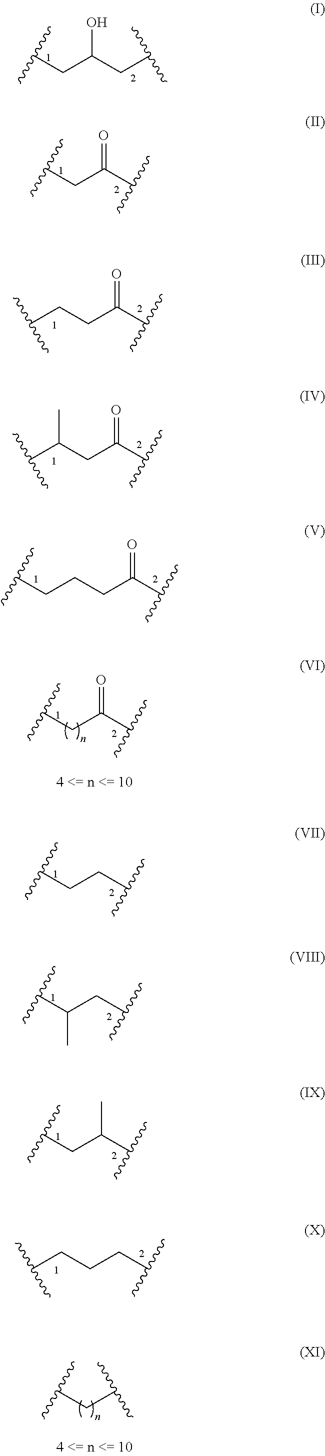

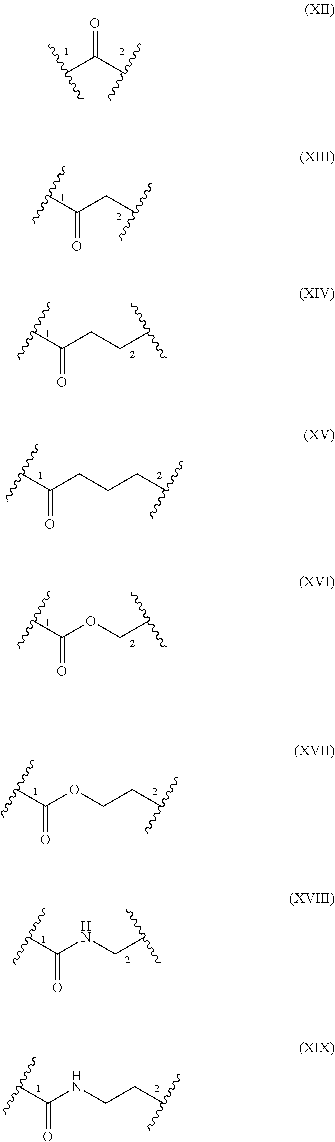

As linkers for thiol-functionalized compounds, the structures (I), (II), (III) and (IV) are preferred. As linkers for Michael acceptors, the structure (XII) is particularly preferred.

For thiol-functionalized compounds, the functional group is the thiol group (—SH).

Particularly preferred thiol-functionalized compounds are esters of the α-thioacetic acid (2-mercaptoacetate), p-thiopropionic acid (3-mercaptopropionate) and 3-thio butyric acid (3-mercaptobutyrate) with monoalcohols, diols, triols, tetraols, pentaols or other polyols as well as 2-hydroxy-3-mercaptopropyl derivatives of monoalcohols, diols, triols, tetraols, pentaols or other polyols. Mixtures of alcohols can also be used here as the basis for the thiol-functionalized compound. Reference is made in this respect to WO 99/51663 A1, the content of which is hereby included in this application.

As particularly suitable thiol-functionalized compounds, the following can be mentioned by way of example: glycol-bis(2-mercaptoacetate), glycol-bis(3-mercaptopropionate), 1,2-propyleneglycol-bis(2-mercaptoacetate), 1,2-propyleneglycol-bis(3-mercaptopropionate), 1,3-propyleneglycol-bis(2-mercaptoacetate), 1,3-propyleneglycol-bis(3-mercaptopropionate), tris(hydroxymethyl)methane-tris(2-mercaptoacetate), tris(hydroxymethyl)methane-tris(3-mercaptopropionate), 1,1,1-tris(hydroxymethyl)ethane-tris(2-mercaptoacetate), 1,1,1-tris(hydroxymethyl)ethane-tris(3-mercaptopropionate), 1,1,1-trimethylolpropane-tris(2-mercaptoacetate), ethoxylated 1,1,1-trimethylolpropane-tris(2-mercaptoacetate), propoxylated 1,1,1-trimethylolpropane-tris(2-mercaptoacetate), 1,1,1-trimethylolpropane-tri(3-mercaptopropionate), ethoxylated 1,1,1-trimethylolpropane-tris(3-mercaptopropionate), propoxylated trimethylolpropane-tris(3-mercaptopropionate), 1,1,1-trimethylolpropane-tris(3-mercaptobutyrate), pentaerythritol-tris(2-mercaptoacetate), pentaerythritol-tetrakis(2-mercaptoacetate), pentaerythritol-tris(3-mercaptopropionate), pentaerythritol-tetrakis(3-mercaptopropionate), pentaerythritol-tris(3-mercaptobutyrate), pentaerythritol-tetrakis(3-mercaptopropionate), pentaerythritol-tris(3-mercaptobutyrate), pentaerythritol-tetrakis(3-mercaptobutyrate), Capcure 3-800 (BASF), GPM-800 (Gabriel Performance Products), Capcure LOF (BASF), GPM-800LO (Gabriel Performance Products), KarenzMT PE-1 (Showa Denko), 2-ethylhexyl thioglycolate, iso-octyl thioglycolate, di(n-butyl)thiodiglycolate, glycol-di-3-mercaptopropionate, 1,6-hexanedithiol, ethyleneglycol-bis(2-mercaptoacetate) and tetra(ethyleneglycol)dithiol.

The thiol-functionalized compound can be used alone or as a mixture of two or more different thiol-functionalized compounds.

Any group which forms a Michael acceptor in combination with the linker is suitable as the functional group for Michael acceptors. Expediently, as the Michael acceptor, a compound having at least two electron-deficient carbon multiple bonds, such as C—C double bonds or C—C triple bonds, preferably C═C double bonds per molecule is used as the functional Michael acceptor group.

According to a preferred embodiment of the invention, the functional group of the Michael acceptor is a compound with the structure (XX):

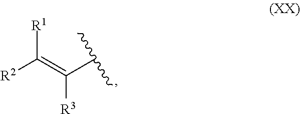

wherein R₁, R₂ and R₃ are, respectively independently of each other, hydrogen or organic residues, such as for example a linear, branched or cyclic, optionally substituted alkyl group, aryl group, aralkyl group (also referred to as aryl-substituted alkyl group) or alkaryl group (also referred to as alkyl-substituted aryl group), including derivatives and substituted versions thereof, and these can contain, independently of each other, additional ether groups, carboxyl groups, carbonyl groups, thiol-analog groups, nitrogen-containing groups or combinations thereof.

Some suitable multi-functional Michael acceptors in the present invention have for example molecules in which some or all of the structures (XX) are residues of (meth)acrylic acid, fumaric acid or maleic acid, substituted versions of combinations thereof which are bonded to the multi-functional Michael acceptor molecule via an ester bond. A compound with structures (XX), which have two or more residues of (meth)acrylic acid, is denoted herein as “polyfunctional (meth)acrylate”. Polyfunctional (meth)acrylate having at least two double bonds, which can act as the acceptor in the Michael addition, are preferred.

Examples of suitable di(meth)acrylates include, but are not limited to: ethylene glycol-di(meth)acrylate, propylene glycol-di(meth)acrylate, diethylene glycol-di(meth)acrylate, dipropylene glycol-di(meth)acrylate, triethylene glycol-di(meth)acrylate, tripropylene glycol-di(meth)acrylate, tertraethylene glycol-di(meth)acrylate, tetrapropylene glycol-di(meth)acrylate, polyethylene glycol-di(meth)acrylate, polypropylene glycol-di(meth)acrylate, ethoxylated bisphenol A-di(meth)acrylate, bisphenol A diglycidyl ether-di(meth)acrylate, resorcinol diglycidyl ether-di(meth)acrylate, 1,3-propanediol-di(meth)acrylate, 1,4-butanediol-di(meth)acrylate, 1,5-pentanediol-di(meth)acrylate, 1,6-hexanediol-di(meth)acrylate, neopentyl glycol-di(meth)acrylate, cyclohexane dimethanol-di(meth)acrylate, ethoxylated neopentyl glycol-di(meth)acrylate, propoxylated neopentyl glycol-di(meth)acrylate, ethoxylated cyclohexane dimethanol-di(meth)acrylate, propoxylated cyclohexane dimethanol-di(meth)acrylate, aryl urethane-di(meth)acrylate, aliphatic urethane-di(meth)acrylate, polyester-di(meth)acrylate and mixtures thereof.

Examples of suitable tri(meth)acrylates include, but are not limited to: trimethylolpropane-tri(meth)acrylate, trifunctional (meth)acrylic acid-s-triazine, glycerol tri(meth)acrylate, ethoxylated trimethylol propane tri(meth)acrylate, propoxylated trimethylol propane tri(meth)acrylate, tris(2-hydroxyethyl) isocyanurate tri(meth)acrylate, ethoxylated glycerol tri(meth)acrylate, propoxylated glycerol tri(meth)acrylate, pentaerythritol tri(meth)acrylate, aryl urethane tri(meth)acrylate, aliphatic urethane tri(meth)acrylates, melamine tri(meth)acrylate, epoxy novolac tri(meth)acrylates, aliphatic epoxy tri(meth)acrylate, polyester tri(meth)acrylate and mixtures thereof.

Examples of suitable tetra(meth)acrylates include, but are not limited to: di(trimethylolpropane) tetra(meth)acrylate, pentaerythritol tetra(meth)acrylate, ethoxylated pentaerythritol tetra(meth)acrylate, propoxylated pentaerythritol tetra(meth)acrylate, dipentaerythritol tetra(meth)acrylate, ethoxylated dipentaerythritol tetra(meth)acrylate, propoxylated dipentaerythritol tetra(meth)acrylate, aryl urethane tetra(meth)acrylates, aliphatic urethane tetra(meth)acrylates, melamine tetra(meth)acrylates, epoxy novolac tetra(meth)acrylates, polyester tetra(meth)acrylates and mixtures thereof.

Mixtures of polyfunctional (meth)acrylates among one another can also be used.

Polyfunctional (meth)acrylates are also suitable as the multi-functional Michael acceptor, in which the skeleton is polymer in nature. The (meth)acrylate groups can be attached to the polymer skeleton in various manners. For example, a (meth)acrylate ester monomer can be attached to a polymerizable functional group by the ester bond and this polymerizable functional group can be polymerized with other monomers such that they leave the double bond of the (meth)acrylate group intact.

In another example, a polymer can be provided with functional groups (such as for example a polyester with residual hydroxyl groups) which can be converted with a (meth)acrylate ester (for example by transesterification) in order to obtain a polymer with (meth)acrylate side groups. In another example, a homopolymer or copolymer, which has a polyfunctional (meth)acrylate monomer (such as trimethylol propane triacrylate), can be produced in such a manner that not all acrylate groups react.

In a particularly preferred embodiment of the invention, the functional Michael acceptor group is a (meth)acrylic acid ester of the previously mentioned polyol compounds. Alternatively, Michael acceptors can also be used in which the structure (XX) is bonded to the polyol skeleton via a nitrogen atom instead of an oxygen atom, such as for example, (meth)acrylic amides.

Mixtures of suitable multi-functional Michael acceptors are also suitable, such as the acrylic amides, nitriles, fumaric acid esters and maleimides known to the person skilled in the art.

The degree of crosslinking of the binder and thus, on the one hand, the strength of the resulting coating and the elastic properties thereof can be set depending on the functionality of the Michael acceptor and/or of the Michael donor.

In the context of the present invention, the relative proportion of multi-functional Michael acceptors to multi-functional Michael donors can be characterized by the reactive equivalent ratio which is the ratio of the number of all functional groups (XX) in the composition to the number of Michael-active hydrogen atoms in the composition. In some embodiments, the reactive equivalent ratio is 0.1 to 10:1, preferably 0.2 to 5:1, more preferably 0.3 to 3:1, even more preferably 0.5 to 2:1 and most preferably 0.75 to 1.25:1.

Although the Michael addition reaction already proceeds without a catalyst and hardening takes place, a catalyst can be used for the reaction between the Michael acceptor and the Michael donor.

The nucleophiles commonly used for Michael addition reactions, in particular between electron-deficient C—C multiple bonds, particularly preferably C═C double bonds, and compounds containing active hydrogen atoms, in particular thiols can be used as catalysts, such as trialkyl phosphines, tertiary amines, a guanidine base, an alcoholate, a tetraorgano ammonium hydroxide, an inorganic carbonate or bicarbonate, a carbonic acid salt or a super base, nucleophile, such as for example a primary or a secondary amine or a tertiary phosphine (see for example C. E. Hoyle, A. B. Lowe, C. N. Bowman, Chem Soc. Rev. 2010, 39, 1355-1387), which are known to the person skilled in the art.

Suitable catalysts are for example triethylamine, ethyl-N,N-diisopropylamine, 1,4-diazabicyclo[2.2.2]octane (DABCO), 1,8-diazabicyclo[5.4.0]undec-7-ene (DBU), 1,5-diazabicyclo[4.3.0]non-5-ene (DBN), dimethylaminopyridine (DMAP), tetramethylguanidine (TMG), 1,8-bis(dimethylamino)naphthaline, 2,6-di-tert-butyl pyridine, 2,6-lutidine, sodium methoxide, potassium methoxide, sodium ethoxide, potassium ethoxide, potassium-tert-butyl alcoholate, benzyltrimethyl ammonium hydroxide, potassium carbonate, potassium bicarbonate, sodium or potassium salts of carbonic acids, the conjugated acidities of which are between pKₐ 3 and 11, n-hexylamine, di-n-propylamine, tri-n-octylphosphine, dimethylphenylphosphine, methyldiphenylphosphine and triphenylphosphine.

The catalyst can be used in catalytic quantities or in an equimolar manner or in excess.

By adding at least one reactive diluent, the viscosity of the composition can be set or adapted correspondingly to the application properties.

In an embodiment of the invention, the composition thus contains further low-viscose compounds as reactive diluents in order to adapt the viscosity of the composition, if required. As reactive diluents, low-viscose compounds can be used as pure substances or in a mixture which react with the constituents of the composition. Examples are allyl ether, allyl ester, vinyl ether, vinyl ester, (meth)acrylic acid ester and thiol-functionalized compounds. Reactive diluents are preferably selected from the group consisting of allyl ethers such as allyl ethyl ether, ally propyl ether, allyl butyl ether, allyl phenyl ether, allyl benzyl ether, trimethylolpropane allyl ether, allyl esters such as acetic acid allyl ester, butyric acid allyl ester, maleic acid diallyl ester, allyl acetoacetate, vinyl ethers, such as butyl vinyl ether, 1,4-butanediol vinyl ether, tert-butyl vinyl ether, 2-ethylhexyl vinyl ether, cyclohexyl vinyl ether, 1,4-cyclohexane dimethanol vinyl ether, ethylene glycol vinyl ether, diethylene glycol vinyl ether, ethyl vinyl ether, isobutyl vinyl ether, propyl vinyl ether, ethyl-1-propenyl ether, dodecyl vinyl ether, hydroxypropyl (meth)acrylate, 1,2-ethanediol di(meth)acrylate, 1,3-propanediol di(meth)acrylate, 1,2-butanediol di(meth)acrylate, 1,4-butanediol di(meth)acrylate, trimethylolpropane tri(meth)acrylate, phenethyl (meth)acrylate, tetrahydrofurfuryl (meth)acrylate, ethyl triglycol (meth)acrylate, N,N-dimethylaminoethyl (meth)acrylate, N,N-dimethylaminomethyl (meth)acrylate acetoacetoxyethyl (meth)acrylate, isobornyl (meth)acrylate, 2-ethylhexyl (meth)acrylate, diethylene glycol di(meth)acrylate, methoxypolyethylene glycol mono(meth)acrylate, trimethylcyclohexyl (meth)acrylate, 2-hydroxyethyl (meth)acrylate, dicyclopentenyl oxyethyl (meth)acrylate and/or tricyclopentadienyl di(meth)acrylate, bisphenol-A-(meth)acrylate, novolac epoxy di(meth)acrylate, di-[(meth)acryloyl-maleoyl]-tricyclo-5.2.1.0.^{2.6}-decane, dicyclopentenyl oxy ethyl crotonate, 3-(meth)acryloyl-oxymethyl-tricylo-5.2.1.0.^{2.6}-decane, 3-(meth)cyclopentadienyl (meth)acrylate, isobornyl (meth)acrylate and decalyl-2-(meth)acrylate.

Other conventional compounds having reactive double bonds can essentially also be used alone or in the mixture with the (meth)acrylic acid esters, e.g. styrene, α-methylstyrene, alkylated styrenes, such as tert-butylstyrene, divinyl benzene and allyl compounds.

The mode of action of the ablative composition according to the invention builds on an endothermic physical and/or chemical reaction, and materials, which require large quantities of energy for the decomposition thereof, are contained in the composition. If the hardened composition is exposed to high temperature, for example the temperature of a fire in the event of fire, a series of chemical and physical processes is initiated. These processes are for example the release of water vapor, change of the chemical composition and the development of inflammable gases, which maintain the oxygen required for combustion distanced from the cable surface. All these processes require a large quantity of energy, which is removed from the fire. After the conversion of all organic constituents has concluded, a stable insulation layer made of inorganic constituents is formed which has an additional insulation effect.

According to the invention, the constituent C thus contains at least one ablative fire protection additive, and both individual compounds and a mixture of a plurality of compounds can be used as the additives.

Expediently, such materials are used as ablative fire protection additives which form energy-absorbing layers by means of water separation, which is stored for example in the form of crystalline water, and water evaporation. The heat energy, which has to be expended in order to separate the water, is removed from the fire in this regard. Such materials are also used which chemically change or decompose, evaporate, sublime or melt in an endothermic reaction in the case of the influence of heat. As a result, the coated substrates are cooled. Inert, i.e. non-flammable gases such as carbon dioxide are often released in the case of decomposition, which also dilutes the oxygen in the direct environment of the coated substrate.

Suitable gas-separating constituents are hydroxides such as aluminum hydroxide and magnesium hydroxide and the hydrates thereof, which separate water, and carbonates such as calcium carbonate, which separate carbon dioxide. Basic carbonates can separate both water and CO₂. A combination of constituents starting the gas separation at different temperatures is preferable. Thus in the case of aluminum hydroxide the water separation starts at approx. 200° C., whereas the water separation in the case of magnesium hydroxide starts at approx. 350° C. such that the gas separation takes place over a larger temperature range.

Suitable ablative materials are, in the case of the influence of heat, water-yielding inorganic hydroxides or hydrates such as sodium, potassium, lithium, barium, calcium, magnesium, boron, aluminum, zinc, nickel, also boric acid and the partly dewatered derivatives thereof.

The following compounds can be mentioned by way of example: LiNO₃.3H₂O, Na₂CO₃H₂O (thermonatrite), Na₂CO₃.7H₂O, Na₂CO₃.10H₂O (soda), Na₂Ca(CO₃)₂.2H₂O (pirssonite), Na₂Ca(CO₃)₂.5H₂O (gaylussite), Na(HCO₃)Na₂CO₃.2H₂O (trona), Na₂S₂O₃.5H₂O, Na₂O₃Si.5H₂O, KF.2H₂O, CaBr₂.2H₂O, CaBr₂.6H₂O, CaSO₄.2H₂O (gips), Ca(SO₄)._{1/2}H₂O (bassanite), Ba(OH)₂.8H₂O, Ni(NO₃)₂.6H₂O, Ni(NO₃)₂.4H₂O, Ni(NO₃)₂.2H₂O, Zn(NO₃)₂.4H₂O, Zn(NO₃)₂.6H₂O, (ZnO)₂(B₂O₃)₂.3H₂O, Mg(NO₃)₂.6H₂O (U.S. Pat. No. 5,985,013 A), MgSO₄.7H₂O (EP1069172A), Mg(OH)₂, Al(OH)₃, Al(OH)₃.3H₂O, AlOOH (boehmite), Al₂[SO₄]₃.nH₂O with n=14-18 (U.S. Pat. No. 4,462,831 B), optionally in the mixture with AlNH₄(SO₄)₂ 12H₂O (U.S. Pat. No. 5,104,917A), KAl(SO₄)₂.12H₂O (EP1069172A), CaO Al₂O₃.10H₂O (nesquehonite), MgCO₃.3H₂O (wermlandite), Ca₂Mg₁₄(Al₁Fe)₄CO₃(OH)₄₂.29H₂O (thaumasite), Ca₃Si(OH)₆(SO₄)(CO₃).12H₂O (artinite), Mg₂(OH)₂CO₃.H₂O (ettringite), 3CaO Al₂O₃.3CaSO₄.32H₂O (hydromagnesite), Mg₅(OH)₂(CO₃)₄.4H₂O (hydrocalumite) Ca₄Al₂(OH)₁₄.6H₂O (hydrotalkite), Mg₆Al₂(OH)₁₆CO₃.4H₂O alumohydrocalcite, CaAl₂(OH)₄(CO₃)₂.3H₂O scarbroite, Al₁₄(CO₃)₃(OH)₃₆ hydrogranate, 3CaO Al₂O₃.6H₂O dawsonite, NaAl(OH)CO₃, water-containing zeolites, vermiculites, colemanite, perlites, mica, alkaline silicates, borax, modified carbons and graphites, silicic acids.

In a preferred embodiment, the hydrated salts are selected from the group consisting of Al₂(SO₄).16-18H₂O, NH₄Fe(SO₄)₂.12H₂O, Na₂B₄O₇.10H₂O, NaAl(SO₄)₂.12H₂O, AlNH₄(SO₄)₂.12-24H₂O, Na₂SO₄.10H₂O, MgSO₄.7H₂O, (NH₄)₂SO₄.12H₂O; KAl(SO₄)₂.12H₂O, Na₂SiO₃.9H₂O, Mg(NO₂)₂.6H₂O, Na₂CO₃.7H₂O and mixtures thereof (EP1069172A).

Particularly preferred are aluminum dioxide, aluminum hydroxide hydrates, magnesium hydroxide and zinc borate since they have an activation temperature below 180° C.

One or more reactive flame retardants can be optionally added to the composition according to the invention. Compounds of this type are incorporated into the binder. An example in the context of the invention are reactive organophosphorus compounds such as 9,10-dihydro-9-oxa-10-phosphaphenanthrene-10-oxide (DOPO) and the derivatives and adducts thereof. Such compounds are for example described in S. V. Levchik, E. D. Weil, Polym. Int 2004, 53, 1901-1929 or E. D. Weil, S. V. Levchik (ed.), Flame Retardants for Plastics and Textiles—Practical Applications, Hanser, 2009.

The ablative fire protection additive can be contained in a quantity of 5 to 99 wt % in the composition, and the quantity substantially depends on the form of application of the composition (spraying, painting and the like). In order to effect the best insulation possible, the proportion of the constituent C in the total formulation is set to be as high as possible. The proportion of the constituent C in the total formulation is preferably 5 to 85 wt % and particularly preferably 40 to 80 wt %.

The composition can contain, in addition to the ablative additives, optionally conventional excipients, such as solvents for example xylol or toluene, wetting agents for example on the basis of polyacrylates and/or polyphosphates, defoamers for example silicon defoamers, thickeners for example alginate thickeners, colorants, fungicides, softeners for example chlorinated waxes, binders, flame retardants or various fillers for example vermiculite, inorganic fibers, quartz sand, micro glass beads, mica, silicon dioxide, mineral wool and the like.

Additional additives such as thickeners, rheological additives and fillers can be added to the composition. As rheological additives for example anti-setting agents, anti-sag agents and thixotropic agents, the following are preferably used, polyhydroxy carbonic acid amides, urea derivatives, salts of unsaturated carbonic acid esters, alkyl ammonium salts of acidic phosphoric acid derivatives, ketoximes, amine salts of p-toluene sulfonic acid, amine salts of sulfonic acid derivatives, as well as aqueous or organic solutions or mixtures of the compounds. Rheology additives on the basis of pyrogenic or precipitated silicic acids or on the basis of silanized pyrogenic or precipitated silicic acids can also be used. The rheology additive is preferably pyrogenic silicic acids, modified and unmodified layer silicates, precipitated silicic acids, cellulose ethers, polysaccharides, PU and acrylate thickeners, urea derivatives, castor oil derivatives, polyamides, and fatty acid amides and polyolefins, if present in solid form, pulverized celluloses and/or suspension agents, such as, for example, xanthan gum.

The composition according to the invention can be made as a two-component system or multicomponent system.

If the constituent A and the constituent B do not react with each other at room temperature without using an accelerator, they can be stored together. If a reaction occurs at room temperature, the constituent A and the constituent B must be arranged separated in a reaction-inhibiting manner. In the presence of an accelerator, said accelerator must be stored either separated from the constituents A and B, or the component, which contains the accelerator, must be stored separated from the other component. This ensures that the two constituents A and B of the binder are mixed together only directly prior to the application and trigger the hardening reaction. This makes the system easier to use.

In a preferred embodiment of the invention, the composition according to the invention is made as a two-component system, and the constituent A and the constituent B are arranged separated in a reaction-inhibiting manner. Accordingly, a first component, which is component I, contains the constituent A and a second component, which is component II, contains the constituent B. This ensures that the two constituents A and B of the binder are mixed together only directly prior to the application and trigger the hardening reaction. This makes the system easier to use.

The multi-functional Michael acceptor is, in this regard, preferably contained in the component I in a quantity of 2 to 95 wt %.

The multi-functional Michael donor is preferably contained in the component II in a quantity of 2 to 95 wt %, particularly preferably in a quantity of 2 to 85 wt %.

The constituent C can, in this regard, be contained as a total mixture or in individual constituents distributed in one constituent or a plurality of constituents. The distribution of the constituent C takes place depending on the compatibility of the compounds contained in the composition, such that neither a reaction between the compounds contained in the composition nor a reciprocal disruption can take place. This is dependent on the compounds used. This ensures that the highest possible proportion of fillers can be achieved. This leads to better cooling, even at low layer thicknesses of the composition.

The composition is applied as a paste with a paintbrush, a roller or by spraying onto the substrate, which can be metallic, plastic in the case of cable routes or soft fittings made of mineral wool. The composition is preferably applied by means of an airless spraying method.

The composition according to the invention, in comparison to the solvent and water-based systems, is characterized by a relatively rapid hardening by means of an addition reaction and thus physical drying is not required. This is, in particular very important if the coated components have to be quickly loaded or further processed, whether it be by coating with a cover layer or moving or transporting the components. The coating is thus also notably less susceptible to external influences on the construction site, such as e.g. impact from (rain)water or dust or dirt which, in the case of solvent or water-based systems, may lead to a leaching out of water-soluble components, or, in the case of dust accumulation, to a reduced ablative effect. The composition remains simple to process in particular, using common spray methods because of the low viscosity of the composition despite the high solid content, which can be up to 99 wt % in the composition without the addition of slightly volatile solvent.

In this regard, the composition according to the invention is suitable, in particular as fire protection coating, in particular sprayable coating for components on a metallic and non-metallic basis. The composition according to the invention can be used in particular in the field of construction as a coating, in particular as fire protection coating for individual cables, cable bundles, cable routes and cable channels or other lines as well as fire protection coating for steel construction elements, but also for construction elements made from other materials such as concrete or wood.

A further subject matter of the invention is therefore the use of the composition according to the invention as a coating, in particular as a coating for construction elements or structural elements made from steel, concrete, wood and other materials, such as for example plastics, in particular as fire protection coating for individual cables, cable bundles, cable routes and cable channels or other lines or soft fittings.

The present invention also relates to objects, which are obtained when the composition according to the invention hardens. The objects have excellent ablative properties.

The following examples serve to further explain the invention.

### EXEMPLARY EMBODIMENTS

The following listed constituents are used for the manufacture of ablative compositions according to the invention. The individual constituents are respectively mixed and homogenized by means of a dissolver. For the application, these mixtures are then mixed and applied either prior to spraying or during spraying.

In order to determine the fire protection properties, the hardened composition was subjected to a test according to EN ISO 11925-2. The test is carried out in a draft-free Mitsubishi FR-D700SC electric inverter combustion chamber. In the test, a small burner flame is directed at an angle of 45° for 30 seconds on the sample surface which corresponds to surface ignition.

Samples with the dimensions 11 cm×29.5 cm and an application thickness of 2-3 mm are respectively used. These samples hardened at room temperature and were aged for three days at 40° C.

After aging for three days at 40° C., the test is carried out for ignitability and height of the attacked surface.

The hardening time and the hardening progress were determined. In this regard, it was tested with a spatula when the hardening of the coating started.

For the following examples 1 and 2, aluminum hydrate (HN 434 from the J.M Huber Corporation, Finland) was used as constituent C and introduced in a quantity of 18 g.

### Example 1

Component A

| Constituent | Quantity [g] |
|---|---|
| Glycol di(3-mercaptopropionate) | 32.8 |
| Durcal 5¹ | 36.0 |

¹Calcium carbonate, ground

Component B

| Constituent | Quantity [g] |
|---|---|
| 1,1,1-tris(hydroxymethyl)propane triacrylate | 27.2 |
| Durcal 5 | 36.0 |

### Example 2

Component A

| Constituent | Quantity [g] |
|---|---|
| Glycol di(3-mercaptopropionate) | 32.7 |
| Durcal 5 | 36.0 |

Component B

| Constituent | Quantity [g] |
|---|---|
| Pentaerythritol triacrylate | 27.3 |
| Durcal 5 | 36.0 |

### Comparative Example 1

A commercial fire protection product (Hilti CFP S-WB) based on aqueous dispersion technology (acrylate dispersion) served as the comparison.

TABLE 1
Results of the determination of the hardening time,
the ignition and the flame height

| | Comparative | | |
|---|---|---|---|
| | example 1 | Example 1 | Example 2 |
| Hardening | 24 h | <1 h | <1 h |
| time | | | |
| Ignition | Yes | No | No |
| Flame height | 150 mm | 32 mm | 26 mm |

1. A fire protection composition having a constituent A, which contains a multi-functional Michael acceptor, which has at least two electron-deficient carbon multiple bonds per molecule as the functional Michael acceptor group, having a constituent B, which contains a multi-functional Michael donor, which has at least two thiol groups as the functional Michael donor group and having a constituent C, which contains at least one ablative fire protection additive.

2. The composition according to claim 1, wherein the multi-functional Michael acceptor group has the structure (XX): 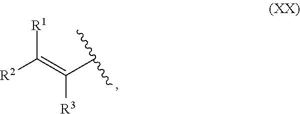
wherein R₁, R₂ and R₃ denote, respectively independently of each other, hydrogen, a linear, branched or cyclic, optionally substituted alkyl group, aryl group, aralkyl group or alkylaryl group, wherein these can contain, independently of each other, additional ether groups, carboxyl groups, carbonyl groups, thiol-analog groups, nitrogen-containing groups or combinations thereof.

3. The composition according to claim 2, wherein each functional Michael acceptor group is in this regard bonded either directly or via a linker to a skeleton.

4. The composition according to claim 3, wherein the skeleton is a monomer, an oligomer or a polymer.

5. The composition according to claim 4, wherein the skeleton is a polymer compound which is selected from the group consisting alkanediols, alkylene glycols, glycerin, 2-(hydroxymethyl)propane-1,3 diol, 1,1,1-tris(hydroxymethyl)ethane, 1,1,1-trimethylolpropane, di(trimethylolpropane), tricyclodecandimethylol, 2,2,4-trimethyl-1,3-pentanediol, bisphenol A, cyclohexane dimethanol, alkoxylated and/or ethoxylated and/or propoxylated derivatives of neopentyl glycol, tetraethylene glycol cyclohexane dimethanol, hexanediol, 2-(hydroxymethyl)propane-1,3-diol, 1,1,1-tris(hydroxymethyl)ethane, 1,1,1-trimethylolpropane and castor oil, pentaerythritol, sugars, polyvalent derivatives thereof or mixtures thereof.

6. The composition according to claim 1, wherein the multi-functional Michael donor has at least three thiol groups per molecule.

7. The composition according to claim 1, wherein the multi-functional Michael donor is selected from the group consisting of glycol-bis(2-mercaptoacetate), glycol-bis(3-mercaptopropionate), 1,2-propyleneglycol-bis(2-mercaptoacetate), 1,2-propyleneglycol-bis(3-mercaptopropionate), 1,3-propyleneglycol-bis(2-mercaptoacetate), 1,3-propyleneglycol-bis(3-mercaptopropionate), tris(hydroxymethyl)methane-tris(2-mercaptoacetate), tris(hydroxymethyl)methane-tris(3-mercaptopropionate), 1,1,1-tris(hydroxymethyl)ethane-tris(2-mercaptoacetate), 1,1,1-tris(hydroxymethyl)ethane-tris(3-mercaptopropionate), 1,1,1-trimethylolpropane-tris(2-mercaptoacetate), ethoxylated 1,1,1-trimethylolpropane-tris(2-mercaptoacetate), propoxylated 1,1,1-trimethylolpropane-tris(2-mercaptoacetate), 1,1,1-trimethylolpropane-tris(3-mercaptopropionate), ethoxylated 1,1,1-trimethylolpropane-tris(3-mercaptopropionate), propoxylated trimethylolpropane-tris(3-mercaptopropionate), 1,1,1-trimethylolpropane-tris(3-mercaptobutyrate), pentaerythritol-tris(2-mercaptoacetate), pentaerythritol-tetrakis(2-mercaptoacetate), pentaerythritol-tris(3-mercaptopropionate), pentaerythritol-tetrakis(3-mercaptopropionate), pentaerythritol-tris(3-mercaptobutyrate), pentaerythritol-tetrakis(3-mercaptopropionate), 2-ethylhexyl thioglycolate, iso-octyl thioglycolate, di(n-butyl)thiodiglycolate, glycol-di-3-mercaptopropionate, 1,6-hexanedithiol, ethyleneglycol-bis(2-mercaptoacetate) and tetra(ethyleneglycol)dithiol.

8. The composition according to claim 1, wherein the reactive equivalent ratio is in the range of 0.1:1 to 10:1.

9. The composition according to claim 10, wherein the constituent A and/or the constituent B also contains a catalyst for the Michael addition reaction.

10. The composition according to claim 1, wherein the at least one ablative fire protection additive is selected from the group consisting of LiNO₃.3H₂O, Na₂CO₃.H₂O (thermonatrite), Na₂CO₃.7H₂O, Na₂CO₃.10H₂O (soda), Na₂Ca(CO₃)₂.2H₂O (pirssonite), Na₂Ca(CO₃)₂.5H₂O (gaylussite), Na(HCO₃)Na₂CO₃.2H₂O (trona), Na₂S₂O₃.5H₂O, Na₂O₃Si.5H₂O, KF.2H₂O, CaBr₂.2H₂O, CaBr₂.6H₂O, CaSO₄.2H₂O (gips), Ca(SO₄)._{1/2}H₂O (bassanite), Ba(OH)₂.8H₂O, Ni(NO₃)₂.6H₂O, Ni(NO₃)₂.4H₂O, Ni(NO₃)₂.2H₂O, Zn(NO₃)₂.4H₂O, Zn(NO₃)₂.6H₂O, (ZnO)₂(B₂O₃)₂.3H₂O, Mg(NO₃)₂.6H₂O (U.S. Pat. No. 5,985,013 A), MgSO₄.7H₂O (EP1069172A), Mg(OH)₂, Al(OH)₃, Al(OH)₃-3H₂O, AIOOH (boehmite), Al₂[SO₄]₃.nH₂O with n=14-18 (U.S. Pat. No. 4,462,831 B), optionally in the mixture with AINH₄(SO₄)₂.12H₂O (U.S. Pat. No. 5,104,917A), KAl(SO₄)₂.12H₂O (EP1069172A), CaO Al₂O₃.10H₂O (nesquehonite), MgCO₃.3H₂O (wermlandite), Ca₂Mg₁₄(Al₁Fe)₄CO₃(OH)₄₂.29H₂O (thaumasite), Ca₃Si(OH)₆(SO₄)(CO₃).12H₂O (artinite), Mg₂(OH)₂CO₃—H₂O (ettringite), 3CaO Al₂O₃.3CaSO₄.32H₂O (hydromagnesite), Mg₅(OH)₂(CO₃)₄.4H₂O (hydrocalumite) Ca₄Al₂(OH)₁₄.6H₂O (hydrotalkite), Mg₆Al₂(OH)₁₆CO₃.4H₂O alumohydrocalcite, CaAl₂(OH)₄(CO₃)₂.3H₂O scarbroite, Al₁₄(CO₃)₃(OH)₃₆ hydrogranate, 3CaOAl₂O₃.6H₂O dawsonite, NaAl(OH)CO₃, water-containing zeolites, vermiculites, colemanite, perlites, mica, alkaline silicates, borax, modified carbons, graphites, silicic acids and mixtures thereof.

11. The composition according to claim 1, wherein the composition also contains organic and/or inorganic aggregates and/or further additives.

12. The composition according to claim 1, which is made as a two-component or multicomponent system.

13. A use of the composition according to claim 1 as a coating.

14. The use according to claim 13 for the coating of construction elements.

15. The use according to claim 13 for the coating of non-metallic substrates.

16. The use according to claim 13 as a fire protection layer, in particular for individual cables, cable bundles, cable routes and cable channels or other lines or soft fittings.

17. Hardened objects obtained by hardening the composition according to claim 1.
